(19) United States
(12) Patent Application Publication
(10) Pub. No.: US 2003/0214279 A1
(43) Pub. Date: Nov. 20, 2003

(54) Current mirroring

(76) Inventor: Dale S. Wedel, Loveland, CO (US)

Correspondence Address: philip W. Woo, C/O SIDLEY AUSTIN BROWN & WOOD LLP, 555 CALIFORNIA STREET, SUITE 5000, SAN FRANCISCO,, CA, 94104-1715, US

(21) Appl. No.: 10/146,863

(22) Filed: May 15, 2002

(51) Int. Cl. G05F 3/16

(52) U.S. Cl. 323/315

(57) ABSTRACT

An apparatus for current mirroring is provided. In one embodiment, the apparatus includes an input node into which an input current can flow. A transistor, through which an output current can flow, servos the input current. The transistor has an emitter, a base, and a collector. A resistor is coupled to the emitter of the first transistor. The output current can flow through the resistor. A feedback circuit has a control terminal coupled to the emitter of the first transistor and the resistor. A voltage across the resistor acts as a control voltage for the feedback circuit. The feedback circuit provides a correction current to the input node, thereby reducing the error between the output current and the input current.

### TECHNICAL FIELD OF THE INVENTION

The present invention relates generally to electrical circuits and, more particularly, to improved current mirroring.

### BACKGROUND

Current mirrors are useful in a number of different applications for electrical circuitry, such as, for example, an operational amplifier. One previously developed implementation of a current mirror is described in George R. Wilson, “A Monolithic Junction FET-n-p-n Operational Amplifier”, IEEE Journal of Solid State Circuits, Vol. SC-3, No. 4, December 1968, which is incorporated by reference herein in its entirety. This implementation, which is commonly referred to as a “Wilson mirror,” offers very accurate direct current (DC) performance when gain (G) is 1. The Wilson mirror, however, is problematic in that it may not be appropriate for low-voltage applications, such as, for example, rail-to-rail gain stages, which can swing almost from one supply voltage rail to the other.

### SUMMARY OF THE INVENTION

According to embodiments of the present invention, a current mirroring circuit with very unique and valuable properties has been developed. In some embodiments, this current mirroring circuit can offer very accurate DC performance at various gain levels. Another advantage of some embodiments of the current mirroring circuit is the low operating headroom or voltage (e.g., less than 1V) that it may require. Thus, the current mirroring circuit can be used in low voltage analog circuitry. Furthermore, with some embodiments, a quiescent or bias point of the output collector of this circuit can be set independently of its gain.

Other aspects and advantages of the present invention will become apparent from the following descriptions and accompanying drawings.

### BRIEF DESCRIPTION OF THE DRAWINGS

For a more complete understanding of the present invention and for further features and advantages, reference is now made to the following description taken in conjunction with the accompanying drawings, in which:

FIG. 1 is a schematic diagram for a current mirroring circuit, according to an embodiment of the present invention.

FIG. 2 is a schematic diagram for one implementation for the embodiment depicted in FIG. 1.

FIG. 3 is a schematic diagram for another implementation for the embodiment depicted in FIG. 1.

FIG. 4 is a schematic diagram for another implementation for the embodiment depicted in FIG. 1.

FIG. 5 is a schematic diagram of a current mirroring circuit, according to another embodiment of the present invention.

FIG. 6 is a schematic diagram for one implementation for the embodiment depicted in FIG. 5.

FIG. 7 is a schematic diagram for another implementation for the embodiment depicted in FIG. 5.

FIG. 8 is a schematic diagram for a current mirroring circuit, according to still yet another embodiment of the present invention.

### DETAILED DESCRIPTION OF THE PREFERRED EMBODIMENTS

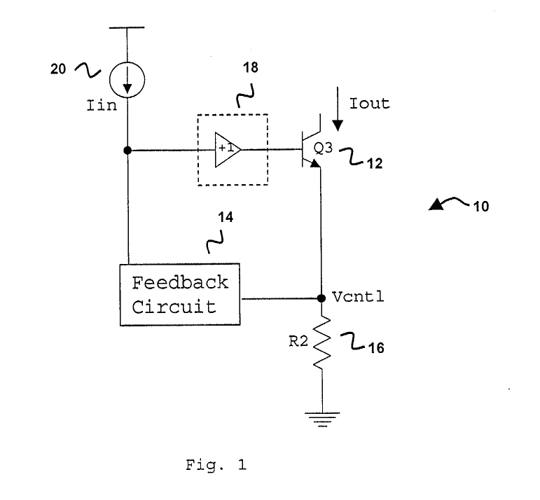

FIG. 1 is a schematic diagram for a current mirroring circuit 10, according to an embodiment of the present invention. As depicted, current mirroring circuit 10 includes a transistor 12 (also labeled Q₃) a feedback circuit 14, a resistor 16 (also labeled R₂) and (optionally) a buffer 18. An input current source 20 provides an input current Iᵢₙ for current mirroring circuit 10. Current mirroring circuit 10 generally functions so that an output current Iₒᵤₜ is equal to the input current Iᵢₙ, times some scaling factor or gain (G). As described in more detail herein, current mirroring circuit 10 may provide good direct current (DC) accuracy.

Current mode feedback is provided in current mirroring circuit 10. The transistor Q₃ is in servo mode. That is, input current Iᵢₙ mainly bypasses transistor Q₃ and flows instead into feedback circuit 14. With the feedback circuit 14, the output current Iₒᵤₜ varies linearly with the input current Iᵢₙ.

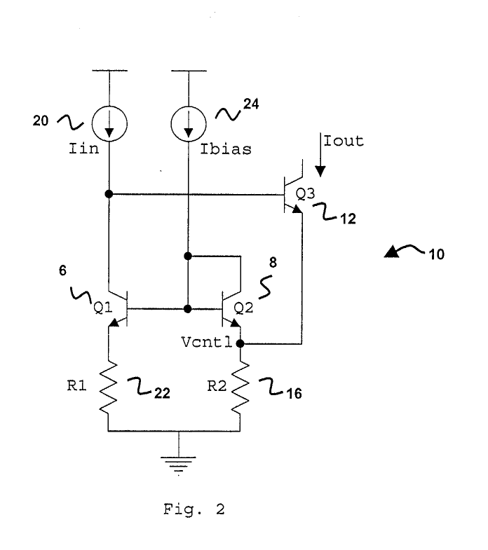

In current mirroring circuit 10, the voltage which controls feedback circuit 14 is the voltage across the resistor R₂. This voltage V_{cntl} has a value of R₂ (Iₒᵤₜ+Iₑ₂) which can be relatively low (and less than a typical diode drop). Note that Iₑ₂ is the emitter current for a transistor Q₂ (shown in FIG. 2) and can be a fixed value. With this, current mirroring circuit 10 can operate at relatively low operational voltage relative to previously developed circuits, such as the Wilson mirror wherein the control voltage may be the value of the base-emitter voltage across a transistor.

As such, current mirroring circuit 10 works well under relatively low voltage conditions (e.g., less than 1 volt), thus making it very suitable for low supply voltage applications. These applications can be, for example, telecommunications systems, displays, and the like, ranging from cell phones to simple battery-powered devices, in which amplification is necessary and in which either power consumption or stable operation in an integrated circuit in its quiescent state is an important consideration.

FIG. 2 is a schematic diagram for one implementation for current mirroring circuit 10 depicted in FIG. 1. As shown, current mirroring circuit 10 includes transistors 6, 8, 12 (also labeled Q₁, Q₂, Q₃, respectively), each of which can be an n-p-n bipolar junction transistor (BJT). Although FIG. 1 illustrates an embodiment implemented with n-p-n BJTs, it should be understood that in other embodiments a current mirroring circuit can be implemented with p-n-p BJTs, a combination of n-p-n and p-n-p BJTs, or in other integrated circuit technologies, such as, for example, metal-oxide semiconductor field effect transistors (MOSFETs). Transistors Q₁, Q₂, Q₃ may be scaled so that the relative current densities are equal.

The base of transistor Q₁ is connected to the base and collector of transistor Q₂. As used herein, the terms “connected,” “coupled,” or any variant thereof, mean any connection or coupling, either direct or indirect, of two or more elements. Transistor Q₂ can be connected as a diode. The emitter of transistor Q₃ is connected in common to the emitter of transistor Q₂. A resistor 22 (also labeled R₁) is connected at one end to the emitter of transistor Q₁ and at the other end to ground (GND). Resistor 16 (R₂) is connected at one end to the emitters of transistors Q₂ and Q₃, and at the other end to ground (GND). The gain of this circuit 10 is fixed by the values of resistors R₁ and R₂, as explained below in more detail.

The input current source 20, which provides the input current Iᵢₙ to current mirroring circuit 10, is coupled to the base of transistor Q₃ and the collector of transistor Q₁. A bias source 24 sets the bias point of diode-connected transistor Q₂. Thus, the base-emitter voltage (V_{be}) of transistor Q₂ is fixed. In some embodiments, the bias source 24 can provide a bias current I_{bias}. In other embodiments, another kind of bias source can be used. The output current Iₒᵤₜ flows through transistor Q₃.

In operation, there is current mode feedback in current mirroring circuit 10. This current mode feedback is provided by the feedback circuit which, as depicted, can be implemented at least in part with some of transistors Q₁, Q₂, and Q₃. With the feedback circuit, the current flowing through transistor Q₁ is set so that, depending on the gain, the output current Iₒᵤₜ is proportional (or, in some cases, equal) to the input current Iᵢₙ. This feedback circuit differs in the connection of the transistors relative to that of previously developed circuits.

As the input current Iᵢₙ increases, it raises the voltage on the base of transistor Q₃. As the base voltage of transistor Q₃ goes up, the output current Iₒᵤₜ increases. That current then flows through resistor R₂. The increased current flowing through resistor R₂ causes a greater voltage drop—i.e., V_{cntl} increases. With the base emitter voltage (V_{be}) of transistor Q₂ fixed by bias source 24, the increasing V_{cntl} raises the voltage at the base of transistor Q₁. As the voltage at the base of transistor Q₁ increases, the current flowing into transistor Q₁ is also increased, which lowers the voltage at the base of transistor Q₃ to equilibrium.

An analysis of the current mirroring circuit 10 shows it to have excellent direct current (DC) accuracy. For the analysis, (referring to FIG. 2) assume that Vα=28 (where Va is the early voltage for the transistors), and that transistors Q₁, Q₂, and Q₃ are identical, and ΔV_{be}_{_{1,2}}<<I_{(1,2)}R_{(1,2)}.

Since the base-emitter voltages of transistor Q₁ (V_{be1}) and transistor Q₂ (V_{be2}) are equal, Iₑ₁R₁=I₂R₂, where Iₑ₁ is the emitter current of transistor Q₁ and flows through resistor R₁, and I₂ is the current flowing through resistor R₂, and is equal to the sum of Iₑ₂ and Iₑ₃ (the emitter currents of transistors Q₂ and Q₃, respectively). Thus, the relationship of the emitter currents is established as:

Iₑ₁=(Iₑ₂+Iₑ₃)(R₂/R₁)

Next, the relation of the bias source current I_{bias} and the transistor terminal currents is developed.

I_{bias}=I_{b1}−Iₑ₂, where I_{b1} is the base current of Q₁.

I_{bias}=I_{b1}−Iₑ₁(R₁/R₂)+Iₑ₃

Next, all terminal currents in the above equation are written with respect to the collector currents.

I_{b1}=I_{c1}/B, where B is the Beta of the transistors, and I_{c1} is the collector current of Q₁

Iₑ₁=−I_{c1}(1+(1/B))

Iₑ₃=I_{c3}(1+(1/B)), where I_{c3} is the collector current of Q₃

Substituting these equations yields,

I_{bias}=I_{c1}/B+I_{c1}(1+(1/B))(R₁/R₂)−I_{c3}(1+(1/B))

Solving for I_{c1} gives

$${I}_{c1} = \frac{{I}_{bias} + {I}_{c3} ( 1 + ( 1 / B ) )}{1 / B + {R}_{1} / ( {BR}_{2} ) + {R}_{1} / {R}_{2}}$$

From FIG. 2, a second equation for I_{c1} can be written

I_{c1}=Iᵢₙ−(I_{c3}/B)

Setting these equations equal gives

$${I}_{i n} - ( {I}_{c3} / B ) = \frac{{I}_{bias} + {I}_{c3} ( 1 + ( 1 / B ) )}{1 / B + {R}_{1} / ( {BR}_{2} ) + {R}_{1} / {R}_{2}}$$

I_{c3}(R₁/B²R₂+1/B²+R₁/R₂B+1/B+1)=Iᵢₙ/B+IᵢₙR₁/BR₂+IᵢₙR₁/R₂−I_{bias}

Since the output current Iₒᵤₜ=I_{c3} (the collector current of Q₃), the equation becomes

Iₒᵤₜ(R₁/B²R₂+1/B²++R₁/R₂B+1/B+1)=Iᵢₙ/B+IᵢₙR₁/BR₂+IᵢₙR₁/R₂−I_{bias}

The gain relationship, Iₒᵤₜ/Iᵢₙ, can now be determined.

$${I}_{out} / {I}_{i n} = \frac{1 / B + {R}_{1} / {BR}_{2} + {R}_{1} / {R}_{2} - {I}_{bias} / {I}_{i n}}{{R}_{1} / {B}^{2} {R}_{2} + 1 / {B}^{2} + {R}_{1} / {R}_{2} B + 1 / B + 1}$$

Neglecting errors due to Beta, the relationship becomes

Iₒᵤₜ=IᵢₙR₁/R₂−I_{bias}

This shows that in one embodiment, the current mirroring circuit 10 has a gain function

$$( \frac{{R}_{1}}{{R}_{2}} )$$

and an offset (I_{bias}). This is advantageous because the quiescent point of the output collector (Q₃) of the current mirroring circuit 10 can be set independently of its gain. Note that the circuit can have different AC and DC gains. Gain function

$$( \frac{{R}_{1}}{{R}_{2}} )$$

is the AC gain.

In order to illustrate the advantages of the present invention, two cases are presented below. The first case is when AC gain (G) is 1, and the second case is when AC gain is 2. When G=1, R₁=R₂, and I_{bias}<<Iᵢₙ. When G=2, R₁=2R₂ and I_{bias}=Iᵢₙ.

Case 1 (G=1)

Let R₁=R₂ and I_{bias}<<Iᵢₙ

$${I}_{out} / {I}_{i n} = \frac{1 / B + {R}_{1} / {BR}_{2} + {R}_{1} / {R}_{2} - {I}_{bias} / {I}_{i n}}{{R}_{1} / {B}^{2} {R}_{2} + 1 / {B}^{2} + {R}_{1} / {R}_{2} B + 1 / B + 1}$$

Since I_{bias}<<Iᵢₙ, the term I_{bias}/Iᵢₙ can be removed and noting that R₁=R₂, the equation becomes

$${I}_{out} / {I}_{i n} = \frac{2 / B + 1}{2 / {B}^{2} + 2 / B + 1}$$

Rearranging, this becomes

$${I}_{out} / {I}_{i n} = 1 - \frac{2}{{B}^{2} + 2 B + 2}$$

Thus, the current mirroring circuit 10 has very accurate DC performance at G=1.

Case 2 (G=2)

Let R₁=2R₂ and I_{bias}=Iᵢₙ

$${I}_{out} / {I}_{i n} = \frac{1 / B + {R}_{1} / {BR}_{2} + {R}_{1} / {R}_{2} - {I}_{bias} / {I}_{i n}}{{R}_{1} / {B}^{2} {R}_{2} + 1 / {B}^{2} + {R}_{1} / {R}_{2} B + 1 / B + 1}$$

Since I_{bias}=Iᵢₙ, the term I_{bias}/Iᵢₙ=1 and noting R₁=2R₂, the equation becomes

$${I}_{out} / {I}_{i n} = \frac{3 / B + 1}{3 / {B}^{2} + 3 / B + 1}$$

Rearranging, this becomes

$${I}_{out} / {I}_{in} = 1 - \frac{3}{{B}^{2} + 3 B + 3}$$

Thus, the current mirroring circuit 10 maintains good DC accuracy at G=2 as well.

Another advantage of the current mirroring circuit 10 is the low operational voltage (headroom) that it requires. The input node (which may be at the collector of transistor Q₁) is only one diode drop (˜0.7V) above ground. The output node (which may be at the collector of transistor Q₃) is one V_{ce}(sat) above ground, where V_{ce}(sat) is the saturation voltage value between the collector and emitter (˜0.2V). The voltage drop across resistors R₁ and R₂ may also be a factor, but is usually negligible in most designs.

The low operational voltage is attributable, in part, to the arrangement of transistors Q₂ and Q₃ in the feedback circuit. Unlike the previously developed Wilson mirroring circuit, in which similar transistors were coupled in series, the transistors Q₂ and Q₃ in current mirroring circuit 10 are connected at their emitters. This avoids one diode drop in voltage level at both input and output nodes relative to the Wilson mirroring circuit; in the Wilson mirroring circuit, the voltage at the input node is two diode drops above ground, and the voltage at the output node is one diode drop plus 1 V_{ce}(sat) above ground. As such, current mirroring circuit 10 works well under relatively low voltage conditions (e.g., less than 1 volt), thus making it very suitable for low supply voltage applications.

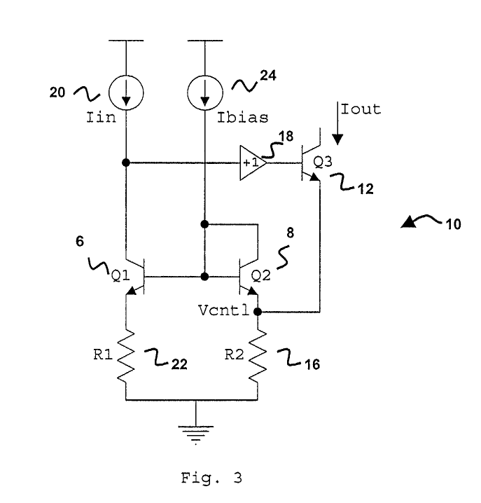

FIG. 3 is a schematic diagram for another implementation for current mirroring circuit 10 depicted in FIG. 1. Referring to FIG. 3, the implementation of current mirroring circuit 10 includes buffer 18 for buffering the input voltage value. The buffering of the input in current mirroring circuit 10 prevents capacitive feedback from output to input. More specifically, the buffer 18 decouples the base-collector capacitance of transistor Q₃.

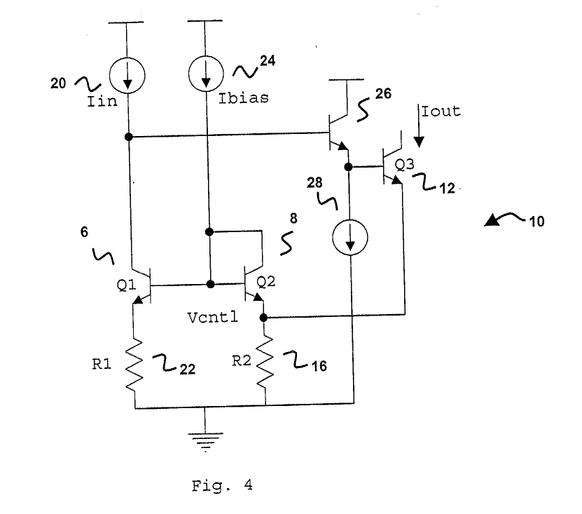

FIG. 4 is a schematic diagram for another implementation for the embodiment depicted in FIG. 1. Referring to FIG. 4, in this implementation for current mirroring circuit 10, the buffer can be implemented with a transistor 26 coupled in emitter-follower arrangement between the input node and the base of transistor Q₃. Transistor 26 is an n-p-n BJT. A current source 28, coupled between the emitter of transistor 26 and ground, biases the transistor 26 on.

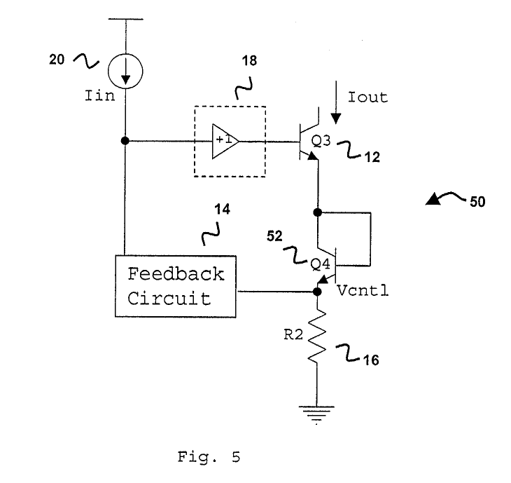

FIG. 5 is a schematic diagram of a current mirroring circuit 50, according to another embodiment of the present invention. Compared to the current mirroring circuit 10 of FIGS. 1-4, current mirroring circuit 50 adds a transistor 52 (also labeled Q₄) to maintain proper operation in certain situations.

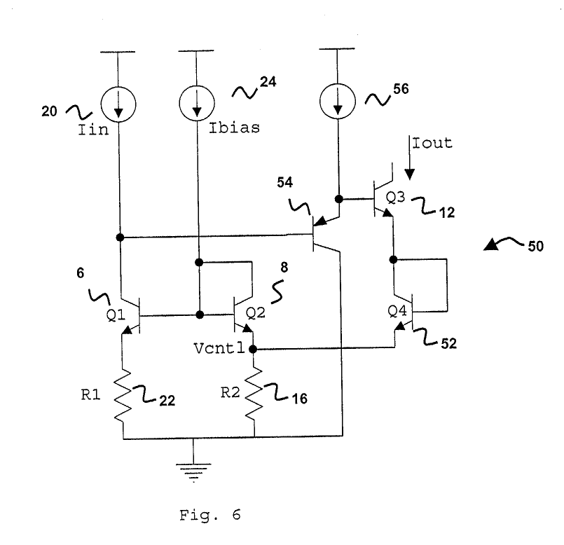

FIG. 6 is a schematic diagram for one implementation for the current mirroring circuit 50 depicted in FIG. 4. In FIG. 6, in current mirroring circuit 50, transistor Q₄ is diode-connected, and is provided to maintain proper operation when buffer 18 is implemented with a p-n-p transistor 54 coupled in emitter-follower arrangement between the input node and the base of transistor Q₃. A current source 56 is coupled to the emitter of transistor 54.

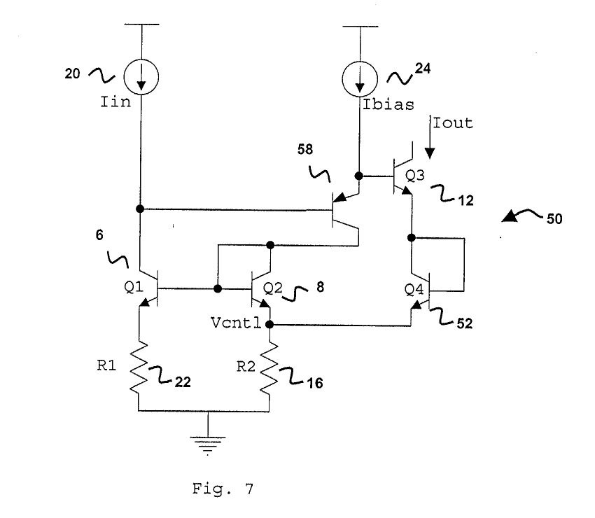

FIG. 7 is a schematic diagram for another implementation for the current mirroring circuit 50. In this implementation, the bias for transistor Q₂ can be passed through the buffer (implemented in part with a transistor 58). This reduces power consumption.

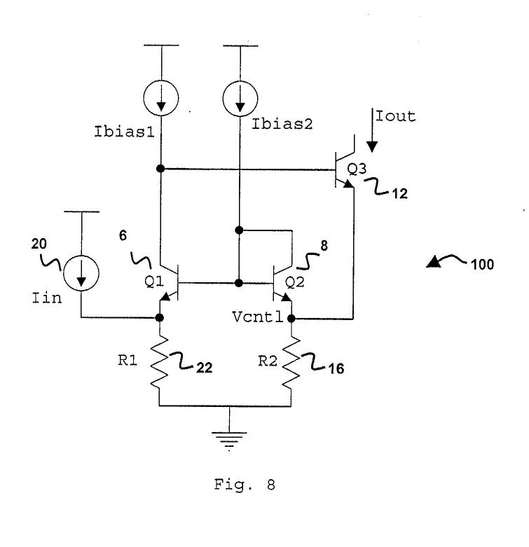

FIG. 8 is a schematic diagram for a current mirroring circuit 100, according to still yet another embodiment of the present invention. In current mirroring circuit 100, the input current Iᵢₙ can be introduced or placed at the emitter of transistor Q₁. A first bias source I_{bias1} fixes the V_{be} of transistor Q₁, and a second bias source I_{bias2} fixes the V_{be} of transistor Q₂.

In this case, the output current Iₒᵤₜ becomes

Iₒᵤₜ=IᵢₙR₁/R₂+I_{bias1}R₁/R₂−I_{bias2}.

In current mirroring circuit 100, bias sources I_{bias1} and I_{bias2} null or substantially reduce the extra base current error, thus providing good DC results at very low operating voltage. In this embodiment, current mirroring circuit 100 provides an advantage over previously designed circuits. Because the V_{be} of transistor Q₁ is fixed by a first bias source I_{bias1} and the V_{be} of Q₂ is fixed by a second bias source I_{bias2}, good linearity is achieved.

Thus, as described herein and with reference to the drawings, embodiments of a current mirroring circuit with significant advantages over previously developed circuits is provided.

Although the present invention and its advantages have been described in detail, it should be understood that various changes, substitutions, and alterations can be made therein without departing from the spirit and scope of the invention as defined by the appended claims. That is, the discussion included in this application is intended to serve as a basic description. It should be understood that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Neither the description nor the terminology is intended to limit the scope of the claims.

It should also be understood that a variety of changes may be made without departing from the essence of the invention. Such changes are also implicitly included in the description. They still fall within the scope of this invention. Further, each of the various elements of the invention and claims may also be achieved in a variety of manners. This disclosure should be understood to encompass each such variation, be it a variation of an embodiment of any apparatus embodiment, or even merely a variation of any element of such. Particularly, it should be understood that as the disclosure relates to elements of the invention, the words for each element may be expressed by equivalent apparatus terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Such changes and alternative terms are to be understood to be explicitly included in the description.

What is claimed is:

1. An apparatus for mirroring current comprising:
a first transistor into which at least a first portion of an input current can flow;
a first resistor coupled to an emitter of the first transistor;
a second transistor operable to be biased by a bias source, and connected at its base and collector to a base of the first transistor;
a second resistor coupled to an emitter of the second transistor; and
a third transistor through which an output current can flow, connected at its emitter to the second resistor and the emitter of the second transistor, and operable to be biased at its base by current mode feedback;
wherein the first transistor and the second transistor form at least a portion of a feedback loop to provide the current mode feedback so that the output current changes proportionately with the input current, wherein a voltage across the second resistor acts as a control voltage for the feedback loop.

2. The apparatus of claim 1 wherein each of the first, second, and third transistors comprise an n-p-n bipolar junction transistor.

3. The apparatus of claim 1 wherein each of the first, second, and third transistors comprise an p-n-p bipolar junction transistor.

4. The apparatus of claim 1 wherein a collector of the first transistor is connected to a base of the third transistor.

5. The apparatus of claim 1 wherein:
the first resistor is coupled between the emitter of the first transistor and ground; and
a second resistor is coupled between ground and the emitters of the second and third transistors.

6. The apparatus of claim 1 wherein:
the first resistor is coupled between the emitter of the first transistor and a supply voltage; and
a second resistor is coupled between the supply voltage and the emitters of the second and third transistors.

7. The apparatus of claim 1 wherein the first and second resistors have the same resistance value.

8. The apparatus of claim 1 wherein the bias source comprises a bias current source.

9. The apparatus of claim 1 wherein the bias source comprises a bias voltage source.

10. The apparatus of claim 1:
wherein the input current is provided at an input node; and
further comprising a buffer coupled between the input node and a base of the third transistor, the buffer operable to prevent capacitive feedback.

11. An apparatus for mirroring current comprising:
a first transistor into which at least a first portion of an input current can flow;
a first resistor coupled to a source of the first transistor;
a second transistor operable to be biased by a bias source, and connected at its gate and drain to a gate of the first transistor;
a second resistor coupled to source of the second transistor; and
a third transistor through which an output current can flow, connected at its source to the second resistor and the source of the second transistor, and operable to be biased at its base by current mode feedback;
wherein the first transistor and the second transistor form at least a portion of a feedback loop to provide current mode feedback so that the output current changes proportionately with the input current, wherein a voltage across the second resistor acts as a control voltage for the feedback loop.

12. The apparatus of claim 11 wherein each of the first, second, and third transistors comprise an n-type metal-oxide semiconductor field effect transistor.

13. The apparatus of claim 11 wherein each of the first, second, and third transistors comprise a p-type metal-oxide semiconductor field effect transistor.

14. The apparatus of claim 11 wherein a drain of the first transistor is connected to a gate of the third transistor.

15. The apparatus of claim 11:
wherein the input current is provided at an input node; and
further comprising a buffer coupled between the input node and a gate of the third transistor, the buffer operable to prevent capacitive feedback.

16. An apparatus for current mirroring comprising:
an input node into which an input current can flow;
a first transistor operable to servo the input current and through which an output current can flow, the first transistor having an emitter, a base, and a collector;
a resistor coupled to the emitter of the first transistor and through which the output current can flow;
a feedback circuit having a control terminal coupled to the emitter of the first transistor and the resistor, wherein a voltage across the resistor acts as a control voltage for the feedback circuit, and wherein the feedback circuit is operable to provide a correction current to the input node, thereby reducing the error between the output current and the input current.

17. The apparatus of claim 16 wherein the feedback circuit comprises:
a second transistor through which at least a portion of the input current can flow;
a third transistor connected in diode-connected arrangement, operable to be biased by a bias source, connected at its base to a base of the second transistor, and connected at its emitter to the emitter of the first transistor.

18. The apparatus of claim 16 further comprising a buffer coupled between the input node and the base of the first transistor, the buffer operable to prevent capacitive feedback.

19. An apparatus for current mirroring comprising:
an input node into which an input current can flow;
a first transistor operable to servo the input current and through which an output current can flow, the first transistor having a drain, a gate, and a source;
a resistor coupled to the source of the first transistor and through which the output current can flow;
a feedback circuit having a control terminal coupled to the source of the first transistor and the resistor, wherein a voltage across the resistor acts as a control voltage for the feedback circuit, and wherein the feedback circuit is operable to provide a correction current to the input node, thereby reducing the error between the output current and the input current.

20. The apparatus of claim 19 wherein the feedback circuit comprises:
a second transistor through which at least a portion of the input current can flow;
a third transistor connected in diode-connected arrangement, operable to be biased by a bias source, connected at its gate to a gate of the second transistor, and connected at its source to the source of the first transistor.

21. The apparatus of claim 19 further comprising a buffer coupled between the input node and the gate of the first transistor, the buffer operable to prevent capacitive feedback.
